(19) United States
(12) Patent Application Publication
(10) Pub. No.: US 2006/0209159 A1
(43) Pub. Date: Sep. 21, 2006

(54) Image forming apparatus

(75) Inventors: Ryuichi Yatsunami, Fukuoka (JP); Yuuji Toyomura, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/376,194

(22) Filed: Mar. 16, 2006

(30) Foreign Application Priority Data
Mar. 17, 2005 (JP) P.2005-076837
Feb. 17, 2006 (JP) P.2006-040571

(51) Int. Cl. B41J 2/415

(52) U.S. Cl. 347/122

(57) ABSTRACT

An image forming apparatus has a plurality of exposure apparatuses that perform exposure using light emitted from a plurality of organic electroluminescence elements as exposure light, wherein light-emitting intensity of the plurality of organic electroluminescence elements is different among the plurality of exposure apparatuses, such as, for example, between a first exposure apparatus and a second exposure apparatus.

### BACKGROUND OF THE INVENTION

1. Field of the Invention

The present invention relates to an image forming apparatus, particularly to an image forming apparatus having an exposure apparatus that uses an organic electroluminescence element.

2. Description of Related Art

An image forming apparatus employing an electrophotographic technology includes an exposure apparatus that exposes a photoconductor, which is evenly charged to a predetermined electric potential level, to exposure light associated with image data, so as to form an electrostatic latent image on the photoconductor. Conventionally, a representative exposure method applied to such exposure apparatus is a laser beam method, which is used in a commonly called laser printer.

The exposure method employing laser beams takes advantage of laser beam properties, which allow the convergence of light on a micro dot. Thus, scanning the photoconductor with the laser beams allows high-resolution exposure. Laser beam scanning, however, requires optical components, such as a polygon mirror, a lens and the like, which occupy a large space, thus making it difficult to reduce a size of the exposure apparatus.

Another conventional representative exposure method is an LED array method, wherein a large number of micro LEDs are arrayed on a semiconductor substrate formed of, for example, silicon or the like, and wherein imaging optics for forming an erecting image at a same magnification, such as a rod lens array, is positioned opposing the LED array, so as to expose one spot on one scanning line to one LED. Unlike the laser beam method, such LED array method requires no space for laser beam scanning, thus enabling size reduction of a whole exposure apparatus.

Different from an exposure method that uses only one light source for scanning and exposure, such as the laser beam method, however, the LED array method uses an array of LED elements in large quantity as exposure light sources. Such configuration has a problem that uneven exposure is unavoidable due to property variations in the LED elements. Further, manufacturing of the LEDs requires expensive semiconductor substrates, thus inevitably leading to a high price of the whole exposure apparatus.

Apart from the above-described methods, research on an exposure apparatus that uses organic electroluminescence elements has been conducted. An organic electroluminescence element is a tiny light-emitting device that utilizes an electroluminescent phenomenon of a solid fluorescent material. Manufacturing of the organic electroluminescence elements is simple, compared to the LEDs, and uniformity among the light-emitting elements is high due to a manufacturing process in which all light-emitting elements are formed together. The organic electroluminescence elements thus feature high correlation in light-emitting intensity between adjacent elements. Therefore, using the organic electroluminescence elements as light sources allows highly uniform exposure with a compact device and further provides a possibility of structuring an affordable exposure apparatus. The research on the organic electroluminescence elements has thus been pursued.

Known as an exposure apparatus that uses such organic electroluminescence elements is a technology disclosed in Related Art 1, for example. Further, a technology disclosed in Related Art 2 is known as an image forming apparatus to which an exposure apparatus that has a light-emitting array as a light source is applied.

Related Art 1 discloses an exposure apparatus having a light-emitting element substrate and at least one image forming unit. The light-emitting element substrate has an array of light-emitting elements on the substrate. The image forming unit forms an image on a photoconductor using beams emitted from the light-emitting elements. The light-emitting elements provided to the light-emitting element substrate are organic electroluminescence elements. Each of the organic electroluminescence elements has a base, an anode, an organic layer and a cathode, which is transparent to a wavelength of light emitted from the light-emitting element.

Related Art 2 discloses a technology to switch exposure levels in an image forming apparatus employing an electrophotographic technology. Under normal conditions, the image forming apparatus forms an image at an exposure level where a potential difference of a latent image contrast is substantially the same as that of a maximum latent image contrast. When a ghost image appears on a photoconductor due to exposure history, the image forming apparatus switches the exposure level to substantially 70% of the normal mode, so that the potential difference of the latent image becomes substantially 60% to 90% of that of the maximum latent image contrast.

[Related Art 1] Japanese Patent Laid-open Publication 2004-327217 [Related Art 2] Japanese Patent Laid-open Publication 2002-067381

The technology disclosed in Related Art 2 allows an exposure apparatus to change the exposure levels by a plurality of steps. In Related Art 2, however, the exposure levels are changed in response to change of environmental conditions or the like. Basically, the image forming apparatus that has a plurality of exposure apparatuses uniformly changes the exposure level on all the exposure apparatuses. That is, Related Art 2 includes no suggestion that the exposure is actively set to different levels among the exposure apparatuses.

An image forming apparatus for color output, which includes a plurality of organic electroluminescence elements having the above-described superior properties, exposes photoconductors based on image data associated with a plurality of colors, including yellow, magenta, cyan and black, so as to form electrostatic latent images; develops the latent images on the photoconductors using toners in respective colors; and sequentially transfers the respective toners onto a medium for final output, such as a sheet of paper (hereinafter referred to as “recording paper”), via a transfer belt or the like so as to form a final image. Due to the configuration, however, such image forming apparatus has a problem that correct output may not be obtained depending on overlapping of the toners in respective colors.

A color image generally consists of toners in three primary colors based on subtractive color mixture (chromatic toners), which are yellow, magenta and cyan; a black toner (achromatic toner); and white, which is a ground color of the recording paper for output. An ideal status of accurate and sharp color is achieved when neighboring toners in respective colors align and do not overlap each other. It is substantially difficult, however, to align pixels formed of toners (hereinafter the “pixels formed of toners” simply referred to as “pixels”) completely in an area having a width of as narrow as several tens of micrometers, and thus the pixels in respective colors overlap each other on an actual image. Slight misalignment of the pixels in respective colors may cause commonly called hue shift, which is particularly noticeable in composite black, that is, black formed of the three color toners of yellow, magenta and cyan.

It is also known that, when a chromatic toner image is overlapped and formed on a black toner image, light having a specific wavelength associated with a toner color is absorbed in a layer where the chromatic toner image is formed, and thus a slight amount of color is developed in a portion where black should be reproduced, thereby degrading the image quality. In this respect, it is preferable to form a black toner on other toner colors, such as yellow, magenta and cyan, as a top surface of the recording paper. In order to form the black toner as the top surface of the recording paper, however, it is required to transfer the black toner after the other chromatic toners are formed, for example. In an image forming apparatus using an electrophotographic process, transfer onto the recording paper tends to be disadvantageous in a later process (decline in transfer efficiency), since toner images are transferred onto the recording paper using electric field power (i.e., the Coulomb force) formed by a high-voltage power supply. In this respect, the configuration, in which the black toner is last transferred onto the recording paper, may cause image quality degradation, including a faint black toner image, which is attributed to the decline in transfer efficiency.

### SUMMARY OF THE INVENTION

The present invention is provided to overcome the above-identified problems. An object of the present invention is to provide an image forming apparatus capable of achieving accurate and sharp color and providing stable output.

The image forming apparatus according to the present invention has a plurality of exposure apparatuses that perform exposure using light emitted from a plurality of organic electroluminescence elements as exposure light, wherein light-emitting intensity of the plurality of organic electroluminescence elements is different among the plurality of exposure apparatuses.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a cross-sectional view illustrating a configuration of an image forming apparatus according to a first embodiment of the present invention;

FIG. 2 is a cross-sectional view illustrating a configuration of an exposure apparatus in the image forming apparatus according to the first embodiment of the present invention;

FIG. 3 is a cross-sectional view illustrating a structure of an organic electroluminescence element used as a light source for the exposure apparatus of the image forming apparatus according to the first embodiment of the present invention;

FIG. 4A is an illustration for examples of shape control of the organic electroluminescence element, in that shapes or sizes of anode and cathode are adjusted, used as the light source for the exposure apparatus of the image forming apparatus according to the first embodiment of the present invention;

FIG. 4B is an illustration for examples of shape control of the organic electroluminescence element, in that shape control is subjected by an insulation layer, used as the light source for the exposure apparatus of the image forming apparatus according to the first embodiment of the present invention;

FIG. 5 illustrates an element shape and arrangement of organic electroluminescence elements used as light sources in the image forming apparatus according to the first embodiment of the present invention;

FIG. 6 illustrates a configuration of an exposure apparatus installed in an image forming apparatus according to a third embodiment of the present invention;

FIG. 7A is a top view illustrating a substrate of the exposure apparatus in the image forming apparatus according to the third embodiment of the present invention;

FIG. 7B is an enlarged view illustrating an essential part of the substrate of the exposure apparatus in the image forming apparatus according to the third embodiment of the present invention;

FIG. 8 is a circuit diagram of the exposure apparatus in the image forming apparatus according to the third embodiment of the present invention; and

FIG. 9 illustrates a status of an electrostatic latent image formed by the exposure apparatus installed in the image forming apparatus according to the third embodiment of the present invention.

### DETAILED DESCRIPTION OF PREFERRED EMBODIMENTS

The embodiments of the present invention are explained in the following, with reference to the above-described drawings. In the drawings referred to below, components are provided with consistent reference numbers and redundant descriptions are omitted. Numeric values described in the embodiments below are provided as examples selectable from a variety of values and are not limited as described. Further, the present invention is not limited to the descriptions provided below and may be appropriately modified to the extent without departing from the substance of the present invention.

First Embodiment

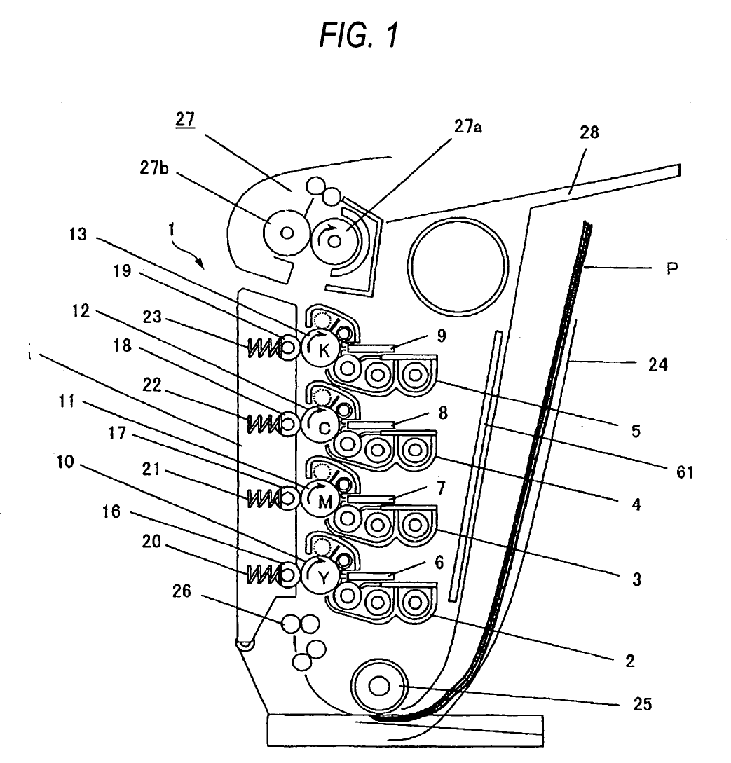

FIG. 1 is a cross-sectional view illustrating a configuration of an image forming apparatus according to a first embodiment of the present invention. Image forming apparatus 1 according to the first embodiment is described in detail below with reference to FIG. 1.

In image forming apparatus 1, as shown in FIG. 1, photoconductors are disposed having predetermined spacings in an order of photoconductor 10 that forms a yellow toner image; photoconductor 11 that forms a magenta toner image; photoconductor 12 that forms a cyan toner image; and photoconductor 13 that forms a black toner image. Provided around respective photoconductors 10, 11, 12 and 13 are exposure apparatuses and developer units. The exposure apparatuses include: exposure apparatus 6 that exposes photoconductor 10 according to yellow image data so as to form an electrostatic latent image on photoconductor 10; exposure apparatus 7 that exposes photoconductor 11 according to magenta image data so as to form an electrostatic latent image on photoconductor 11; exposure apparatus 8 that exposes photoconductor 12 according to cyan image data so as to form an electrostatic latent image on photoconductor 12; exposure apparatus 9 that exposes photoconductor 13 according to black image data so as to form an electrostatic latent image on photoconductor 13. The developer units include: developer unit 2 that develops the electrostatic latent image in yellow; developer unit 3 that develops the electrostatic latent image in magenta; developer unit 4 that develops the electrostatic latent image in cyan; and developer unit 5 that develops the electrostatic latent image in black.

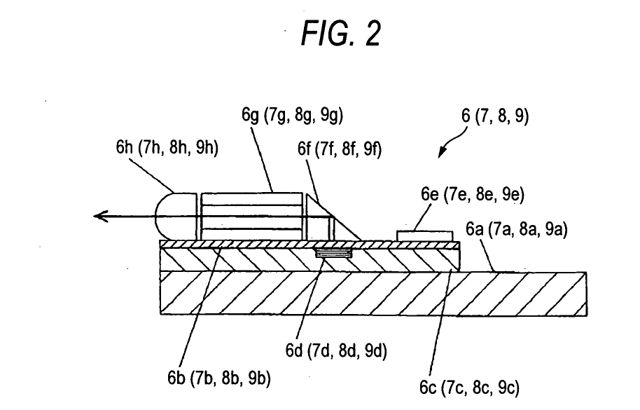

FIG. 2 is a cross-sectional view illustrating a configuration of exposure apparatuses 6, 7, 8 and 9 in image forming apparatus 1 according to the first embodiment of the present invention. The configuration of exposure apparatuses 6, 7, 8 and 9 is described in detail below with reference to FIG. 2.

As shown in FIG. 2, exposure apparatuses 6, 7, 8 and 9 are provided with a plurality of light-emitting sections that include at least organic electroluminescence elements (hereinafter referred to as organic EL elements) 6d, 7d, 8d and 9d

The light-emitting sections include organic EL elements 6d, 7d, 8d and 9d; and drivers 6e, 7e, 8e and 9e. Organic EL elements 6d, 7d, 8d and 9d are mounted on substrates 6b, 7b, 8b and 9b and serve as light sources. Drivers 6e, 7e, 8e and 9e, which are provided onto substrates 6b, 7b, 8b and 9b, supply organic EL elements 6d, 7d, 8d and 9d with voltages or currents associated with the image data, so that organic EL elements 6d, 7d, 8d and 9d emit light. Sealing materials 6c, 7c, 8c and 9c hermetically seal substrates 6b, 7b, 8b and 9b to, so as to shield organic EL elements 6d, 7d, 8d and 9d from air.

The light-emitting sections as constructed above are fixed onto head bases 6a, 7a, 8a and 9a as shown in FIG. 2. Installed on substrates 6b, 7b, 8b and 9b are: prisms 6f, 7f, 8f and 9f that refract light emitted from organic EL elements 6d, 7d, 8d and 9d; fiber arrays 6g, 7g, 8g and 9g that transmit the light from prisms 6f, 7f, 8f and 9f; and cylindrical lenses 6h, 7h, 8h and 9h that focus the light from fiber arrays 6g, 7g, 8g and 9g in a sub scanning direction. Prisms 6f, 7f, 8f and 9f; fiber arrays 6g, 7g, 8g and 9g; and cylindrical lenses 6h, 7h, 8h and 9h constitute waveguides.

Continued below are the descriptions with reference to FIG. 1.

Charging units (chargers) and cleaners (neither shown in the figure) are disposed around photoconductors 10, 11, 12 and 13, which serve as image bearers. The charging units are pressured against photoconductors 10, 11, 12 and 13, so as to charge surfaces of photoconductors 10, 11, 12 and 13 to even electric potentials. The cleaners remove remaining toners from photoconductors 10, 11, 12 and 13 after image transfer.

Developer units 2, 3, 4 and 5 include developer rollers (developers), stirring members, supply rollers and doctor blades (none of the components shown in the figure). The developer rollers deposit the toners and develop the toner images on photoconductors 10, 11, 12 and 13, on which the electrostatic latent images were formed on peripheral surfaces thereof as having been exposed to the light from exposure apparatuses 6, 7, 8 and 9. The stirring members stir the toners reserved in toner tanks. The supply rollers supply the toners to the developer rollers while stirring the toners. The doctor blades adjust the toners supplied to the developer rollers to a predetermined thickness and charge the toners by friction.

As shown in FIG. 1, transfer unit 15 is disposed in a location facing exposure apparatuses 6, 7, 8 and 9; photoconductors 10, 11, 12 and 13; and developer units 2, 3, 4 and 5. Transfer unit 15 sequentially overlaps and transfers the toner images in respective colors developed on photoconductors 10, 11, 12 and 13 onto a sheet of recording paper (recording medium) P, so as to form a color toner image. Transfer unit 15 is provided with transfer rollers 16, 17, 18 and 19 associated with photoconductors 10, 11, 12 and 13 respectively; and springs 20, 21, 22 and 23 that pressure transfer rollers 16, 17, 18 and 19 against photoconductors 10, 11, 12 and 13 respectively.

Paper feeder unit 24 is provided to store recording paper P, on an opposite side to transfer unit 15 with respect to a paper feeding route formed between photoconductors 10, 11, 12 and 13; and transfer rollers 16, 17, 18 and 19. Paper feeder roller 25 feeds recording paper P one by one from paper feeder unit 24. On a paper feeding route from paper feeder unit 24 to transfer unit 15, registration roller 26 is provided so as to feed recording paper P to transfer unit 15 at a predetermined timing. On a paper feeding route that conveys recording paper P, on which the color toner images were overlapped and transferred at transfer unit 15, fuser unit 27 is provided. Fuser unit 27 has heating roller 27a and pressure roller 27b, which is pressured against heating roller 27a. Pressure and heat, which are generated by pinching rotation of heating roller 27a and pressure roller 27b, fuse the color toner images, which were transferred onto recording paper P, to recording paper P.

Described below are processes for forming a color image on recording paper P in image forming apparatus 1. In image forming apparatus 1 having the configuration shown in FIG. 1, exposure apparatus 6 first forms the electrostatic latent image on photoconductor 10, based on a yellow component of the image data. The developer roller (not shown in the figure) that carries the yellow toner develops the electrostatic latent image on photoconductor 10 as the yellow toner image. During the process, paper feeder roller 25 takes recording paper P from paper feeder unit 24, and then registration roller 26 feeds recording paper P to transfer unit 15 while controlling a predetermined timing. Then, photoconductor 10 and transfer roller 16 sandwich and feed recording paper P therebetween, during which transfer roller 16 is provided with a predetermined bias potential and thereby the yellow toner image is transferred from photoconductor 10 onto recording paper P.

While the yellow toner image is being transferred onto recording paper P, exposure apparatus 7 subsequently forms the electrostatic latent image on photoconductor 11, based on a magenta component of the image data, and the developer roller (not shown in the figure) develops the magenta toner image. Onto recording paper P to which the yellow toner image was transferred, the magenta toner image is transferred overlapping the yellow toner image. In a similar manner, the cyan toner image and the black toner image are formed and transferred, thus completing overlapping of the four color toner images.

Then, recording paper P, on which the color toner images were formed, is conveyed to fuser unit 27. Fuser unit 27 heats and fuses the transferred color toner images onto recording paper P, and thereby forms a full color image on recording paper P. Recording paper P completed with a series of the color image forming processes is ejected on paper ejection tray 28.

Controller 61 generates image data and light intensity correction data. The image data are used to drive exposure apparatuses 6, 7, 8 and 9 for the respective color components (i.e., to control on and off of organic EL elements 6d, 7d, 8d and 9d provided to exposure apparatuses 6, 7, 8 and 9 shown in FIG. 2), based on image data externally transferred to image forming apparatus 1. The light intensity correction data are used to correct variation in light-emitting intensity of the individual organic EL elements.

The waveguide according to the first embodiment may be achieved by employing a thin-film waveguide, a micro lens array and the like, or a combination of the components, instead of the configuration described earlier. It is further possible to combine the components above with another optical system, such as a prism or a cylindrical lens or the like.

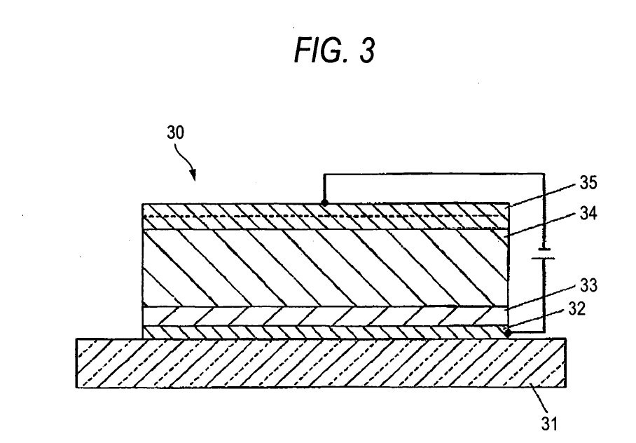

FIG. 3 is a cross-sectional view illustrating a structure of the organic EL element used as a light source for the exposure apparatus of image forming apparatus 1 according to the first embodiment of the present invention.

Organic EL elements 6d, 7d, 8d and 9d provided to exposure apparatuses 6, 7, 8 and 9 (refer to FIG. 2; hereinafter collectively referred to as organic EL elements 30) as light sources are described in detail below with reference to FIG. 3.

Organic EL element 30 in FIG. 3 corresponds to organic EL elements 6d, 7d, 8d and 9d in FIG. 2. Organic EL elements 30 are categorized into several groups based on material used in light-emitting layer 34. One representative group is organic EL element 30 that has an organic compound having a low-molecular weight in light-emitting layer 34. Organic EL element 30 of such group is produced mainly by vacuum deposition.

Another group is a generally called polymer organic EL element, which has a polymer compound in light-emitting layer 34. Using a solution containing dissolved material that forms light-emitting layer 34 of organic EL element 30 allows production of the polymer organic EL element in a spin coat method, an ink-jet method, a printing method and the like. Due to the simple process, the polymer organic EL element has drawn attention as a technology expected to achieve cost reduction or area increase.

Typical organic EL element 30 is produced by laminating a plurality of function layers, such as charge injection layer 33, light-emitting layer 34 and the like, between anode 32 and cathode 35. Organic EL element 30 of the first embodiment is the commonly called polymer organic EL element that has polymer material in the function layers. The structure of organic EL element 30 is described below.

As shown in FIG. 3, organic EL element 30 of the first embodiment is formed of translucent substrate 31, on which translucent anode 32 formed of, such as ITO (indium tin oxide) or the like, is provided. Formed on translucent anode 32 is a thin film of charge injection layer 33, on which polymer material is laminated as light-emitting layer 34. Then, cathode 35 is formed on light-emitting layer 34.

When applying a direct voltage or a direct current to anode 32 of organic EL element 30 as a positive electrode and to cathode 35 as a negative electrode, holes are injected into light-emitting layer 34 from anode 32 via charge injection layer 33, and electrons are injected from cathode 35. In light-emitting layer 34, the injected holes and electrons are recombined to excitons. When the excitons transit from an excited state to a ground state, a luminescent phenomenon occurs.

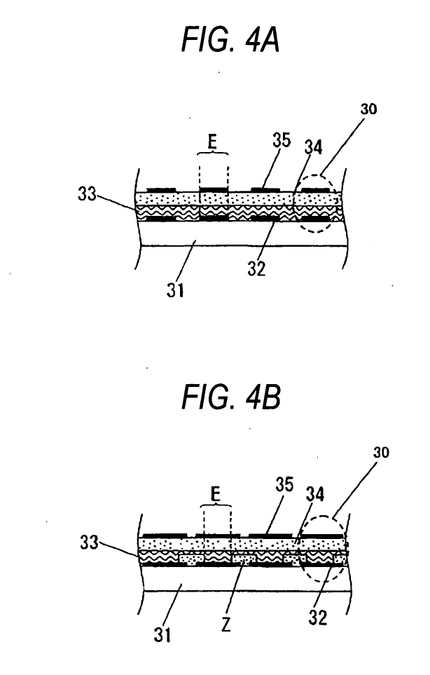

FIG. 4A is an illustration for examples of shape control of the organic electroluminescence element 30 used as the light source for the exposure apparatus of the image forming apparatus 1 according to the first embodiment of the present invention, in that shapes or sizes of anode or cathode is adjusted, and FIG. 4B is an illustration for examples of shape control of the organic electroluminescence element used as the light source for the exposure apparatus of the image forming apparatus according to the first embodiment of the present invention, in that shape control is subjected by an insulation layer;

A method for controlling light-emitting zone E of organic EL element 30 is described below with reference to FIGS. 4A and 4B

There are two methods in order for organic EL element 30 to emit light having a particular shape or area: to adjust a shape or a size between anode 32 and cathode 35, so that a portion sandwiched between the two electrodes have a desired shape and area as shown in FIG. 4A; and to provide insulating layer Z between anode 32 and charge injection layer 33 as shown in FIG. 4B. In either of the methods, a zone where the light is emitted is shown as zone E (light-emitting zone E) in FIGS. 4A and 4B.

The structure of organic EL element 30 is simple in the method of FIG. 4A. However, it is difficult to ensure positioning accuracy when forming anode 32 and cathode 35 as light-emitting zone E becomes very small. Further, when constructing micro organic EL element 30 associated with a micro pixel, a line width between the two electrodes becomes very narrow, thus causing a problem such as heat generation due to increased resistance. On the other hand, no problem occurs relating to the line width and the positioning accuracy of anode 32 and cathode 35 in the method of FIG. 4B, though production of insulating layer Z is required.

Although either of the above-described methods may be applied to embody the present invention, the first embodiment employs the method shown in FIG. 4B for producing organic EL element 30. Insulating layer Z can be formed of photoresist material or the like and be produced in a generally called photolithography method, thereby enabling the production of organic EL element 30 that has significantly high resolution, good reproducibility and a particular shape or arrangement. Using insulating layer Z as described above allows easy forming of a desired area and shape for light-emitting zones E of organic EL elements 30 provided to respective exposure apparatuses 6, 7, 8 and 9.

Organic EL elements 6d, 7d, 8d and 9d in FIG. 2 are provided on substrates 6b, 7b, 8b and 9b, while being shown in a state upside down of organic EL element 30 described with reference to FIG. 3. Further, substrate 31 in FIG. 3 may be formed separately from substrates 6b, 7b, 8b and 9b shown in FIG. 2 and may be disposed in a further lower portion of substrates 6b, 7b, 8b and 9b. Substrate 31 itself may also form substrates 6b, 7b, 8b and 9b.

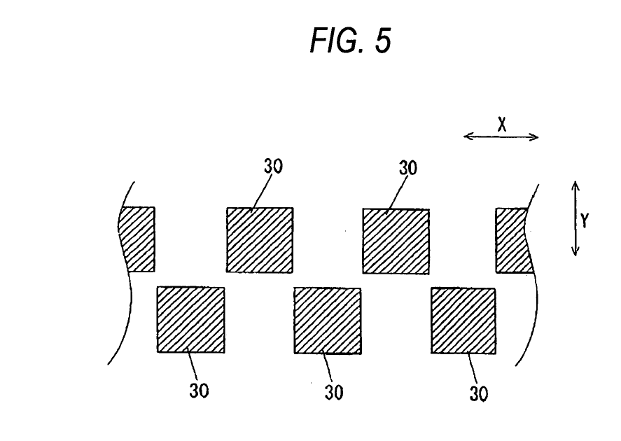

FIG. 5 illustrates an element shape and arrangement of the organic EL elements used as the light sources in the image forming apparatus according to the first embodiment of the present invention.

Organic EL elements 30 used in image forming apparatus 1 are described in detail below with reference to FIG. 5.

Since an essential part when describing organic EL elements 30 is the area and shape of above-described light-emitting zones E, the descriptions below focus on the part in further detail.

FIG. 5 shows the area, shape and arrangement of light-emitting zones E of organic EL elements 30 (refer to FIG. 4B) according to the first embodiment. It is assumed that Image forming apparatus 1 has an alignment density of 600 dpi (dot per inch) of organic EL elements 30. That is, image forming apparatus 1 forms 600 pixels in one inch based on image data. An alignment pitch of pixels in this case is one 600^{th} of one inch, that is, 42.3 μm.

In FIG. 5, a horizontal direction (direction X) indicates a main scanning direction, and a vertical direction (direction Y) indicates a sub scanning direction, which is a moving direction of recording paper P (refer to FIG. 1). Organic EL elements 30, which are installed in image forming apparatus 1 so as to form the latent images in yellow, magenta, cyan and black, are arranged in a checkerboard pattern. Such arrangement of organic EL elements 30 substantially improves the flexibility in the area and shape of organic EL elements 30.

When gaps between organic EL elements 30 arranged in the checkerboard pattern are compensated in the sub scanning direction, there is no problem with image formation in actual exposure using organic EL elements 30. To compensate the gaps, image data processing is temporally delayed with use of, for example, a memory and the like, and then lighting of organic EL elements 30 is controlled. Further, light-emitting zone E (refer to FIG. 4B) of each of organic EL elements 30 is controlled by insulating layer Z. Each of organic EL elements 30 is also provided with anode 32 and cathode 35 for independent drive.

The description continues below with reference to FIGS. 1 and 4A and 4B.

In the first embodiment, the plurality of organic EL elements 30 installed in exposure apparatuses 6 and 7 are provided with light-emitting zones E having a substantially square shape of a 60-μm side and a distance between centers thereof of 42.3 μm. Exposure apparatus 6 for yellow performs exposure (or transfer) first in a series of the processes through output. That is, exposure apparatus 6 is in a most upstream position in image forming apparatus 1, and exposure apparatus 7 for magenta is in a next upstream position. For remaining exposure apparatuses 8 and 9 for cyan and black respectively, organic EL elements 30 are provided with light-emitting zones E having a substantially square shape of a 42.3-μm side and a distance between centers thereof of 42.3 μm. As described above, light-emitting zones E are different among the exposure apparatuses, while resolution (the alignment pitch of organic EL elements 30) of the exposure apparatuses is identical at 600 dpi in the first embodiment.

In other words, at least one of the shape and the area of light-emitting zones E of the plurality of organic EL elements is configured different among the plurality of exposure apparatuses in the first embodiment. Further, the area of light-emitting zones E of the plurality of organic EL elements 30 is configured larger for an exposure apparatus that performs exposure in an earlier stage. From a different perspective, light-emitting zones E of organic EL elements 30 provided in the exposure apparatus for the earliest exposure have a larger area than light-emitting zones E of organic EL elements 30 provided in the remaining exposure apparatuses in the configuration.

According to the example above, the area and shape of organic EL elements 30 provided to exposure apparatus 6 for yellow and to exposure apparatus 7 for magenta are identical, that is, the substantially square shape of 60×60 μm². Further, the area and shape of organic EL elements 30 provided to exposure apparatus 8 for cyan and to exposure apparatus 9 for black are identical, that is, the substantially square shape of 42.3×42.3 μm². It is possible, however, to have a configuration that meets a relationship requirement of: “the area of light-emitting zones E of respective organic EL elements 30 on exposure apparatus 6 for yellow > the area of light-emitting zones E of respective organic EL elements 30 on exposure apparatus 7 for magenta > the area of light-emitting zones E of respective organic EL elements 30 on exposure apparatus 8 for cyan > the area of light-emitting zones E of respective organic EL elements 30 on exposure apparatus 9 for black.”

Since the present invention is to reduce damage caused by overlapping of the pixels in different colors, it is also possible to have a configuration opposite to the example above, so as to meet a relationship requirement of: “the area of light-emitting zones E of respective organic EL elements 30 on exposure apparatus 6 for yellow = the area of light-emitting zones E of respective organic EL elements 30 on exposure apparatus 7 for magenta < the area of light-emitting zones E of respective organic EL elements 30 on exposure apparatus 8 for cyan = the area of light-emitting zones E of respective organic EL elements 30 on exposure apparatus 9 for black.” It is further possible to have a configuration that meets a relationship requirement of: “the area of light-emitting zones E of respective organic EL elements 30 on exposure apparatus 6 for yellow < the area of light-emitting zones E of respective organic EL elements 30 on exposure apparatus 7 for magenta < the area of light-emitting zones E of respective organic EL elements 30 on exposure apparatus 8 for cyan < the area of light-emitting zones E of respective organic EL elements 30 on exposure apparatus 9 for black.”

Further, light-emitting zones E of organic EL elements 30 may have a shape having round corners, instead of the square. Removing corners from light-emitting zones E provides above-described light-emitting layer 34 (refer to FIG. 3) with an even thickness, when light-emitting layer 34 is produced in a spin coat method and the like.

Described below are image forming processes when image forming apparatus 1 is configured with organic EL elements 30 having light-emitting zones E of the above-described area, shape and arrangement. To simplify description, recording paper P is printed in green on an entire surface thereof at a coverage rate of 50% for respective colors. Yellow and cyan toners are used for the printing. When the toners in two colors precisely align alternating at an interval of 42.3 μm and having no gap (i.e., in the checkerboard pattern), a human being perceives output as perfect green.

In image forming apparatus 1, however, it is extremely difficult to place pixels in yellow and cyan on exact same locations relative to photoconductors 10 and 12 (i.e., to align the pixels in different colors so that the pixels neighbor each other and form the checkerboard pattern on recording paper P later) due to eccentricity and inclination of photoconductors 10 and 12. Further taking into account misalignment of the pixels and other factors due to change in a feed speed of recording paper P, it is practically impossible to precisely align the neighboring pixels of two kinds (two colors) so as to form the checkerboard pattern. Thus, it is unavoidable that the pixels overlap each other to some extent.

Apart from the configuration described in the first embodiment, described below is a case where image forming apparatus 1 is configured with organic EL elements 30 having light-emitting zones E of a 42.3-μm square for exposure of yellow and cyan. When image forming apparatus 1 prints on the entire surface of recording paper P similar to above, the yellow pixels cover substantially a half of the area of recording paper P in the checkerboard pattern, right after recording paper P passes through transfer roller 16, since the coverage rate is 50% for the respective colors.

When overlapping on recording paper P, the cyan pixels are placed so as to align between the yellow pixels in exposure. Pixel forming positions shift, however, due to a variety of factors described above. When the alignment of the pixels shifts by substantially 20 μm in a horizontal direction, for example, the cyan pixels cover 20-μm portions of the yellow pixels on a side thereof to which the cyan pixels shift, and thereby the cyan color becomes dominant as covering a top surface of recording paper P. Meanwhile, for 20-μm portions on an opposite side, where the cyan pixels are supposed to be placed, no toner is deposited and thereby a ground color of recording paper P appears. In other words, when a color of recording paper P is white, hue shift towards cyan occurs, though an intended color is green, and the density appears reduced since the ground color, which is white, of recording paper P is exposed. Consequently, the color looks substantially different from an expected color of green.

Returning to the configuration in the first embodiment, since the yellow toner forms the pixels of a 60-μm square, the yellow pixels cover substantially more than half of the area of recording paper P in the checkerboard pattern, right after recording paper P passes through transfer roller 16. When subsequently overlapping on recording paper P, the cyan pixels are placed so as to align between the yellow pixels in exposure. As explained above, however, the pixel forming positions shift.

When the pixel alignment shifts by substantially 20 μm in the horizontal direction similar to above, cyan covers the 20-μm portions of the yellow pixels on the side thereof to which the cyan pixels shift, and thus cyan becomes dominant and reduces an area of the yellow pixels. In this case, however, a majority of positions where the cyan pixels are supposed to be placed have already been covered by the yellow pixels. As a result, a ratio of areas where the yellow and cyan pixels appear on an output surface is substantially 1:1, which is thus perceived as green for human eyes. Although only a positional relationship between the yellow and cyan pixels is described above, a similar description applies to output in other colors, including medium colors.

As described above, in image forming apparatus 1 of the first embodiment, the area of light-emitting zones E of organic EL elements 30 is different among the plurality of exposure apparatuses, so as to effectively improve decline in the placement area of the later-formed pixels when the pixels overlap. Image forming apparatus 1 thereby achieves accurate and sharp color and provides stable output. Further, in image forming apparatus 1 having the plurality of exposure apparatuses 6, 7, 8 and 9 as described above, light-emitting zones E of organic EL elements 30 provided to respective exposure apparatuses 6, 7, 8 and 9 have different areas, so that light-emitting zones E of organic EL elements 30 located upstream in terms of the image forming order, that is, light-emitting zones E of organic EL elements 30 for exposure in an earlier process have a larger area than light-emitting zones E of organic EL elements 30 located downstream, that is, light-emitting zones E of organic EL elements 30 for exposure in a later process. Thereby, even when the toner in different color overlaps as being transferred in the later process, the placement area of the earlier exposed pixels are prevented from reducing significantly, thus allowing proper color reproduction and high effectiveness for proper output.

When the pixel area is different among exposure apparatuses 6, 7, 8 and 9 as described above, the print density of the large pixels is higher than that of the small pixels, according to a principle of area modulation. However, the principle applies when the light-emitting intensity per unit area of organic EL elements 30 provided to respective exposure apparatuses 6, 7, 8 and 9 is identical. It is possible, for example, to lower a drive current for organic EL elements 30 having large light-emitting zones E, compared to that for organic EL elements 30 having small light-emitting zones E, so as to lower an absolute value of an electric potential of a latent image formed on photoconductors 10, 11, 12 and 13 (i.e., the drive current is lowered as light-emitting zones E become larger, which means to equalize the energy to form one pixel in the respective exposure apparatuses). The level of the absolute value of the electric potential closely relates to deposition volume of the toners in the development process. Thus, by actively controlling the electric potential (i.e., applying a concept of density modulation), the print density per pixel can be substantially equal, even when an area of the latent image changes.

Described above is a case where the area of light-emitting zones E of organic EL elements 30 is different among predetermined exposure apparatuses (as described earlier, for example, the area of light-emitting zones E of organic EL elements 30 in exposure apparatuses 6 and 7 is equal; the area of light-emitting zones E of organic EL elements 30 in exposure apparatuses 8 and 9 is equal; and the area of light-emitting zones E of organic EL elements 30 in exposure apparatuses 6 and 8 is not equal). Besides changing the area of light-emitting zones E of organic EL elements 30, it is also possible to change the shape of light-emitting zones E of organic EL elements 30 installed in respective exposure apparatuses 6, 7, 8 and 9. For example, light-emitting zones E of organic EL elements 30 in exposure apparatus 6 (i.e., organic EL elements 6d in FIG. 2), which is located upstream in the image forming processes, may have a different shape from light-emitting zones E of organic EL elements 30 in exposure apparatus 8 (i.e., organic EL elements 8d in FIG. 2), which is located downstream in the image forming processes. Setting the shape of light-emitting zones E different as above is also an effective method for achieving the accurate and sharp color and providing the stable output.

More specifically, the shape of insulating layer Z, which was described with reference to FIG. 4B, is adjusted, and light-emitting zones E of organic EL elements 30 are formed in a wedge shape and arranged in a vertically or horizontally asymmetrical pattern. For example, light-emitting zones E of all organic EL elements 30 may be formed in the wedge shape, and a direction of an apex of the wedge may be different in the upstream and downstream processes of image forming (sequentially changing the apex direction by 90 degrees accommodates the four colors). By using the plurality of organic EL elements 30 having the above-described shape of light-emitting zones E, the pixels formed by different exposure apparatuses (exposure apparatuses 6 and 8, for example) never completely overlap each other on recording paper P, even when the area of the light-emitting zones of respective organic EL elements 30 is identical. Thereby, the area on which the pixels is formed in the downstream process can be surely secured, thus achieving the accurate and sharp color and providing the stable output. The method of changing the shape of light-emitting zones E as described above is effective particularly when a shift amount is not so large in pixel alignment.

Further, in a case where the shape of light-emitting zones E of organic EL elements 30 is different per exposure apparatuses 6, 7, 8 and 9 as described above, when a total area of the light-emitting zones in each of exposure apparatuses 6, 7, 8 and 9 is equal, advantages can be obtained, including that driving power to the plurality of organic EL elements 30 for respective exposure apparatuses 6, 7, 8 and 9 can be uniform, and that specifications of substrate 31 for driving can be standardized.

In image forming apparatus 1 having the plurality of exposure apparatuses as described above, appropriately changing the shape or the area of light-emitting zones E of organic EL elements provided to respective exposure apparatuses 6, 7, 8 and 9 achieves the accurate and sharp color and provides the stable output. To change the shape or the area of light-emitting zones E of organic EL elements 30, it is only required to change the shape of insulating layer Z as already explained, that is, to change a pattern of a photomask used for forming insulating layer Z. Since only the photomask pattern needs to be changed and the remaining production processes can remain the same, it is substantially easy to apply effectiveness of the present invention.

Similar to the changing of the area among the respective exposure apparatuses, it is possible that, for example, the shape of light-emitting zones E of organic EL elements 30 provided to exposure apparatuses 6 and 7 is identical; the shape of light-emitting zones E of organic EL elements 30 provided to exposure apparatuses 8 and 9 is identical; and the shape of light-emitting zones E of organic EL elements 30 provided to exposure apparatuses 6 and 8 is different. The changing of the shape as above is also effective to reduce the overlapping of the pixels.

Similar effectiveness may be obtained by, for example, changing a cross-section shape of laser beams (a shape of exposure spots on surfaces of photoconductors 10, 11, 12 and 13) or an aperture, or reshaping an LED array. It should be noted, however, that the above-described changing methods are substantially difficult in both production and control and thus not practical, since additional optical element, production process and the like are required.

Further, image forming apparatus 1 of the first embodiment described above is installed with exposure apparatuses 6, 7, 8 and 9 that use organic EL elements 30 as the light sources. Compared to an image forming apparatus employing a conventional laser beam method or an LED array method, image forming apparatus 1 thus achieves further size reduction, exposure of high uniformity, plus price reduction.

It is noted that the shape, area, arrangement and the like of light-emitting zones E of organic EL elements 30 described in the first embodiment are merely examples to embody the present invention and need to be modified appropriately according to a detailed apparatus configuration and a target image. It is also possible to change both the area and shape of organic EL elements 30 among exposure apparatuses 6, 7, 8 and 9.

Second Embodiment

Described below is a second embodiment of the present invention. Figures used in the first embodiment are used below and thus descriptions on same components are omitted.

Image forming apparatus 1 according to the second embodiment is described in detail below with reference to FIGS. 1, 2, 4A, 4B, and 5.

Image forming apparatus 1 of the second embodiment has a similar configuration to image forming apparatus 1 described in the first embodiment, which is provided with four exposure apparatuses 6, 7, 8 and 9 for yellow, magenta, cyan and black. In exposure apparatuses 6, 7, 8 and 9 of the second embodiment, however, resolution of organic EL elements 30 as exposure light sources is 1,200 dpi.

Further, image forming apparatus 1 of the second embodiment features an area or a shape of organic EL elements 30 provided to exposure apparatus 9 (organic EL elements 9d) for exposure based on black image data, which are different from a shape of organic EL elements 30 for exposure of other three colors. Thus, further details on the feature are provided below.

It is known that black functions differently compared to the other three colors in various image output. Most characters, lines and the like are output in black, for example. Further in image output, generally called composite black, which is made principally by mixing three colors, that is, yellow, magenta and cyan, may actually turn out dark green due to constrains on image forming apparatus 1, including transfer performance onto recording paper P. A presence of black is thus essential in order to provide a crisp and clear image. Further for business use, printouts are mostly in monochrome, which uses only black.

The function of black is important in image forming apparatus 1 as described above. The present invention is thus provided to address the situation. In image forming apparatus 1 of the second embodiment, organic EL elements 30 provided to exposure apparatus 9 for exposure based on the black image data (organic EL elements 9d in FIG. 2) are arranged in a checkerboard pattern as shown in FIG. 5, similar to arrangement in the first embodiment. Light-emitting zones E of organic EL elements 30 have a size-of a 32-μm side. For organic EL elements 30 provided to exposure apparatuses 6, 7 and 8 for exposure based on image data of the other three colors (exposure apparatuses 6d, 7dand 8d in FIG. 2), light-emitting zones E have a size of 21.7-μm side, which corresponds to 1,200 dpi. In image forming apparatus 1 of the second embodiment, therefore, only light-emitting zones E of organic EL elements 30 provided to exposure apparatus 9 for exposure based on the black image data (organic EL elements 9d in FIG. 2) have a different area from light-emitting zones E of organic EL elements 30 provided to exposure apparatuses 6, 7 and 9 for exposure of yellow, magenta and cyan respectively (organic EL elements 6d, 7d and 8d in FIG. 2). Further, light-emitting zones E of organic EL elements 30 for black (organic EL elements 9d in FIG. 2) have a larger area than light-emitting zones E of organic EL elements 30 for yellow, magenta and cyan (organic EL elements 6d, 7dand 8d in FIG. 2)

Image forming apparatus 1 of the second embodiment having the configuration described as above is particularly effective for business use where graphics and texts are mixed. In business use, where most output is on white recording paper P, black is used for printing characters and lines. Due to high contrast of a black toner-against white recording paper P, uneven or faint output is visible compared to the other colors. The uneven or faint output is attributed to an uneven toner density, which stems from unevenness in deposition volume of the black toner on photoconductor 13.

Generally, a toner particle size is substantially 7 μm, and thus as few as a dozen toner particles are deposited on an exposure spot on photoconductor 9 having a width of 21.7 μm, which indicates that a number of the toner particles on the exposure spot may vary.

However, in image forming apparatus 1 of the second embodiment, only for organic EL elements 30 for exposure based on the black image data (organic EL elements 9d in FIG. 2), light-emitting zones E of organic EL elements 30 included in exposure apparatus 9 for exposure based on the black image data have a 32-μm square shape. The number of the toner particles that form one pixel thereby significantly increases to several tens. Further, overlapping of neighboring pixels is ensured, thus resolving the problems such as uneven or faint print.

For printout in business use, unlike printout of photographs and the like, it is highly likely that the black pixels exist alone without overlapping the other pixels. Thus, there is hardly any problem with the overlapping of the neighboring pixels. It is rather effective in reducing the uneven or faint output.

Further in image forming apparatus 1 shown in FIG. 1, the black toner is transferred onto recording paper P in the last process, that is, after the other color toners are formed on recording paper P. Thus, transfer efficiency declines when, for example, the other color toners are already formed on recording paper P. The decline in the transfer efficiency is resulted from that a gradient of a bias potential applied for transfer becomes moderate as the other color toners already formed are deposited and thicker on recording paper P. Therefore, transfer conditions for the black toner are more adverse than those for the other colors. As described above, however, when the black pixels are larger than the other color pixels, the number of the individual black toner particles to be transferred is greater, even though the transfer efficiency is degraded. In this regard, it is also possible to effectively reduce the uneven or faint output, when the black toners are formed larger than the other color toners.

As described above, it is significantly effective in image forming apparatus 1 that light-emitting zones E of organic EL elements 30 associated with exposure of black (organic EL elements 9d in FIG. 2) have a larger area than light-emitting zones E of organic EL elements 30 associated with exposure of the other colors (organic EL elements 6d, 7d and 8d in FIG. 2).

Further, when focusing on black, it is also effective that light-emitting zones E of organic EL elements 30 have a different shape, as described in the first embodiment, so as to achieve accurate and sharp color and provide stable output. More specifically, for example, when only light-emitting zones E of organic EL elements 30 provided to exposure apparatus 9 for exposure of black (organic El elements 9d in FIG. 2) have a different shape from light-emitting zones E of organic EL elements 30 provided to exposure apparatuses 6, 7 and 8 for exposure of yellow, magenta and cyan respectively (organic El elements 6d, 7d and 8d in FIG. 2), color is accurate and sharp and output is stable.

Similar to the first embodiment, for example, when all light-emitting zones E of organic EL elements provided to exposure apparatuses 6, 7, 8 and 9 have a wedge shape and when only an apex of the wedge shape of light-emitting zones E of organic EL elements 30 provided to exposure apparatus 9 (organic EL elements 9d in FIG. 2) is pointed in a different direction, a probability that the black pixels overlap the other color pixels can be lowered, even when the light-emitting area of respective organic EL elements 30 is identical. Thereby, the area that contains only the black toner can be surely secured, thus achieving the accurate and sharp color and providing the stable output.

The area of light-emitting zones E of organic EL elements 30 described in the second embodiment is used merely as examples. The area needs to be appropriately adjusted so as to obtain optimum output when actually structuring image forming apparatus 1.

Third Embodiment

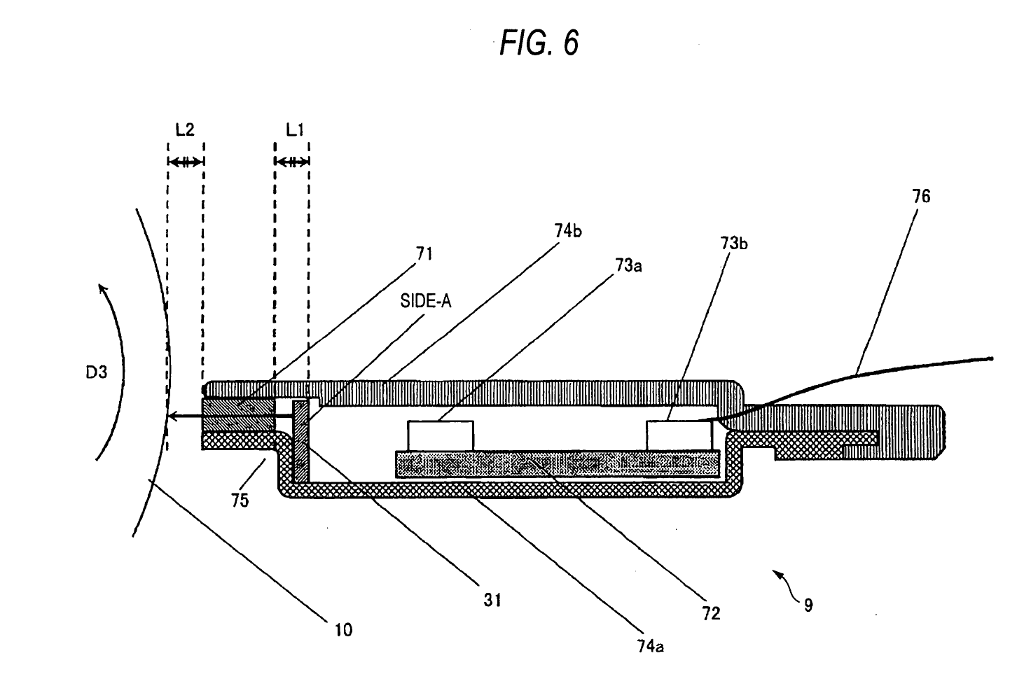

FIG. 6 illustrates a configuration of an exposure apparatus installed in image forming apparatus 1 according to a third embodiment of the present invention. The configuration of the exposure apparatus according to the third embodiment is described in detail below with reference to FIG. 6.

Image forming apparatus 1 of the third embodiment is different from described in the first and second embodiments regarding the configuration of the exposure apparatus. However, the remaining configuration of image forming apparatus 1 is the same as described in the first and second embodiments, and thus description thereof is omitted below.

Exposure apparatuses of the third embodiment have a same configuration regardless of associated colors. When the exposure apparatuses are described below, therefore, exposure apparatus 9 relating to exposure of black is used as a representative for convenience sake. When a color needs to be described specifically, individual numbers are used such as exposure apparatus 8 or exposure apparatus 9.

Exposure apparatus 9 installed in image forming apparatus 1 shown in FIG. 6 exposes photoconductor 10 based on black image data and forms a latent image on a surface of photoconductor 10.

Substrate 31, which was already described in the first embodiment, is provided on side A with light-emitting elements, that is, organic EL elements 30 as light sources, which are formed perpendicular to the figure (a main scanning direction) at a resolution of 600 dpi (dot per inch).

Fiber array 71 includes rod lenses formed of plastic or glass (not shown in the figure) in array. Fiber array 71 directs light emitted from organic EL elements 30, which are formed on side A of substrate 31, to the surface of photoconductor 10, on which the latent image is formed, as an erecting image at a same magnification. A positional relationship among substrate 31, fiber array 71 and photoconductor 10 is adjusted, so that one focal point of fiber array 71 is on side A of substrate 31 and that the other focal point is on the surface of photoconductor 10. That is, L1, which is a distance from side A to a closer side of fiber array 71, and L2, which is a distance from the other side of fiber array 71 to the surface of photoconductor 10, are equal (L1=L2).

Relay substrate 72 is formed of; for example, a glass epoxy substrate. At least connector A 73a and connector B 73b are mounted on relay substrate 72. Relay substrate 72 relays via connector B 73b to substrate 31 image data, light intensity correction data and other control signals, which are supplied externally to exposure apparatus 9 via cable 76, which is such as, for example, a flexible flat cable.

In terms of bonding strength or reliability in various environments where exposure apparatus 9 is placed, it is difficult to directly mount the connectors on a surface of substrate 31. In the third embodiment, therefore, an FPC (flexible print circuit) is used (not shown in the figure; details described later) as a method for connecting connector A 73a a to relay substrate 72 and substrate 31. To bond substrate 31 and the FPC, an ACF (anisotropic conductive film) or the like is used, so as to directly connect to an ITO (indium tin oxide) electrode or the like formed in advance on substrate 31.

Connector B 73b externally connects exposure apparatus 9. Although the connection using the ACF and the like generally causes a bonding strength problem, providing connector B 73b on relay substrate 72 for a user to connect exposure apparatus 9 ensures the sufficient strength as an interface that the user accesses.

Frame A 74a is formed of a metal plate, which is, for example, bent and processed. Provided on a side facing photoconductor 10 of frame A 74a is L-shaped portion 75, along which substrate 31 and fiber array 71 are disposed. A side surface of frame A 74a on a photoconductor 10 side is aligned to a side surface of fiber array 71. Frame A 74a further supports a portion of one side of substrate 31. Ensuring forming accuracy of L-shaped portion 75 as above allows precise alignment of the positional relationship between substrate 31 and fiber array 71. Since frame A 74a requires size accuracy as described above, it is preferable to form frame A 74a of metal. Forming frame A 74a of metal also prevents noise impact to a control circuit formed on substrate 31 and to an electronic component, such as an IC chip, mounted on the surface of substrate 31.

Frame B 74b is formed of molded plastic. Frame B 74b is provided with a cut-out (not shown in the figure) near connector B 73b on, so that the user can access connector B 73b through the cut-out. Cable 76 connected to connector B 73b externally supplies exposure apparatus 9 with the image data; the light intensity correction data; the control signals, including a clock signal, a line sync signal and the like; a drive power source for the control circuit; driver power sources for the organic EL elements as light-emitting devices; and the like.

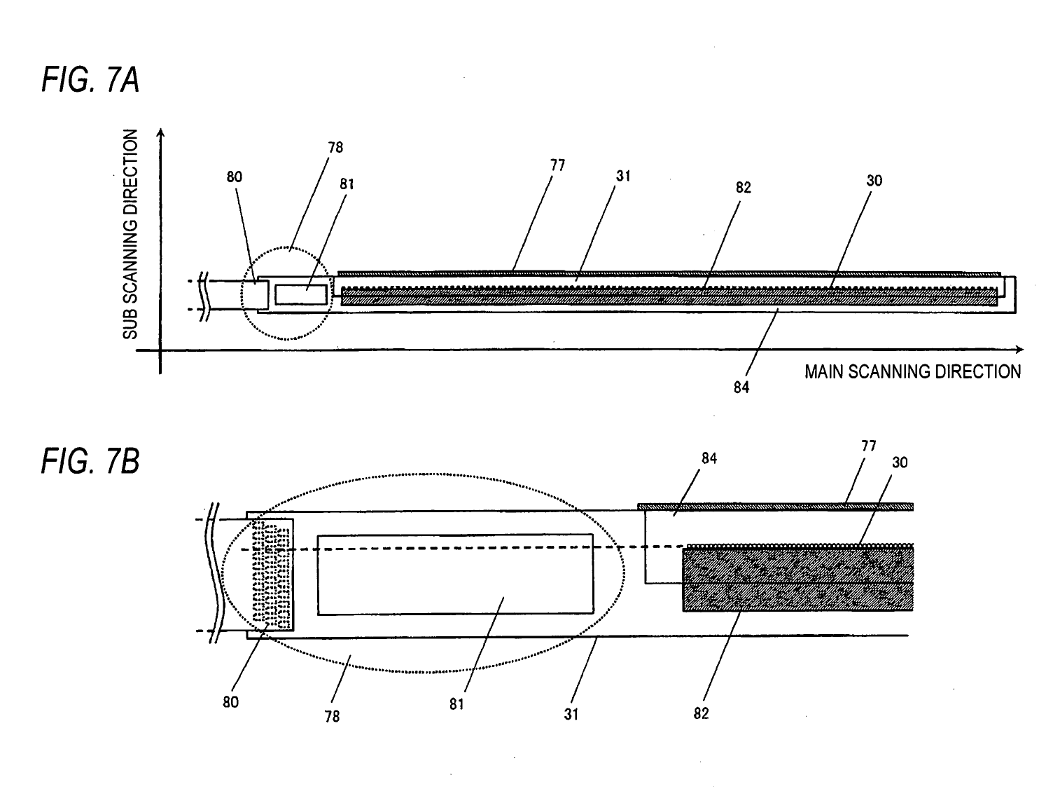

FIG. 7A is a top view illustrating substrate 31 of exposure apparatus 9 in image forming apparatus 1 according to the third embodiment of the present invention. FIG. 7B is an enlarged view illustrating an essential part of substrate 31 of exposure apparatus 9 in image forming apparatus 1 according to the third embodiment of the present invention.

A structure of substrate 31 of the third embodiment is described in detail below with reference to FIGS. 6 and 7.

Substrate 31 shown in FIG. 7 is a rectangular-shaped glass substrate having long and short sides and a thickness of substantially 0.7 mm. Along the long sides (the main scanning direction), a plurality of organic EL elements 30, which are light-emitting elements, are aligned in a row. In the third embodiment, the light-emitting elements required at least for exposure on an A4 size (210 mm) are aligned along the long side direction. A length of substrate 31 in the long side direction is 250 mm including a space to place drive controller 78, which will be described later. Substrate 31 is described as rectangular in the third embodiment for simplicity. However, substrate 31 may have a modified shape, such as provided with a cut-out for positioning to attach substrate 31 to frame A 74a.

Drive controller 78 receives externally supplied control signals (signals to drive organic EL elements 30 as the light-emitting elements) and, based on the control signals, controls drive of organic EL elements 30. Drive controller 78 includes an interface unit that externally receives the control signals for substrate 31; and an IC chip (a source driver) that controls the drive of organic EL elements 30, based on the control signals received via the interface unit. The interface unit and the IC chip will be described later.

FPC (flexile print circuit) 80 is an interface unit that connects connector A 73a of relay substrate 72 and substrate 31. FPC 80 is connected directly, not through a connector or the like, to a circuit pattern provided on substrate 31 (not shown in the figure). The signals and power sources externally supplied to exposure apparatus 9 are provided to substrate 31 via relay substrate 72 shown in FIG. 6 and then via FPC 80. The signals and power sources include, for example: the image data; the light intensity correction data; the control signals, including the clock signal, the line sync signal and the like; the drive power source for the control circuit; and the drive power sources for organic EL elements as the light-emitting elements.

In the third embodiment, 5,120 pieces of organic EL elements 30 as the light sources of exposure apparatus 9 are aligned in a row at the resolution of 600 dpi in the main scanning direction. Turning on and off of organic EL elements 30 is controlled individually by a TFT circuit, which will be descried later.

Source driver 81, which is supplied as the IC chip that controls the drive of organic EL elements 30, is flip-chip mounted on substrate 31. A bare chip is used as source driver 81 so as to be mounted on a glass surface. Supplied externally to source driver 81 of exposure apparatus 9 via FPC 80 are the power sources; the control related signals, such as the clock signal, the line sync signal and the like; and the light intensity correction data (e.g., 8-bit multi-value data). The light intensity correction data are generated by controller 61, which was described in the first embodiment, and are input to source driver 81. Source driver 81, as described in detail later, sets drive parameters for organic EL elements 30. More specifically, source driver 81 sets drive current values for individual organic EL elements, based on the light intensity correction data received via FPC 80.

The image forming apparatus of the present invention has the plurality of exposure apparatuses 9 that perform exposure using the light emitted from the plurality of organic EL elements 30 as exposure light. Light-emitting intensity of the plurality of organic EL elements 30 is configured to be different among the plurality of exposure apparatuses. Controller 61 (refer to FIG. 1) sets values of the above-described light intensity correction data individually for exposure apparatuses 6, 7, 8 and 9, so that the light-emitting intensity of organic EL elements 30 provided to respective exposure apparatuses 6, 7, 8 and 9 is different among the plurality of exposure apparatuses. The preceding phrase “the light-emitting intensity . . . is configured to be different among the plurality of exposure apparatuses” means that “the light-emitting intensity is configured to be different among at least two or more of the exposure apparatuses,” but not that “the light-emitting intensity is configured to be different among all of the exposure apparatuses.” Thus, a case is included where the light-emitting intensity is different between two of the exposure apparatuses.

Further, the light intensity correction data mean data to correct variations in the light-emitting intensity of all organic EL elements 30 provided to exposure apparatus 9, the light-emitting intensity individually measured by a predetermined jig in a manufacturing process of exposure apparatus 9. More specifically, the light intensity correction data are values associated with drive currents required so that respective organic EL elements 30 emit light at even light intensity, and are independent values for individual organic EL elements 30. The light intensity correction data are then set in source driver 81, which programs the current values for driving individual organic EL elements 30 into a drive circuit (i.e., a commonly called current program), so as to drive individual organic EL elements 30 at the current values associated with the light intensity correction data. Thereby, the light-emitting intensity of individual organic EL elements 30 is corrected so as to be uniform.

The light intensity correction data are then multiplied by coefficients of, such as, for example, 1.0 for exposure apparatus 6 for yellow, 0.9 for exposure apparatus 7 for magenta, 0.8 for exposure apparatus 8 for cyan and 0.7 for exposure apparatus 9 for black, so as to obtain final light intensity correction data. The final light intensity correction data enable the correcting of the variations in the light-emitting intensity of organic EL elements 30 in respective exposure apparatuses 6, 7, 8 and 9 and the setting of different light-emitting intensity to organic EL elements 30 among exposure apparatuses 6, 7, 8 and 9 while organic EL elements 30 are on. According to the setting above, the light-emitting intensity of organic EL elements 30 is higher in exposure apparatus that performs exposure in an earlier stage.

Further, to obtain the final light intensity correction data, the light intensity correction data may be multiplied by coefficients of, such as, for example, 0.7 for exposure apparatus 6 for yellow, 0.7 for exposure apparatus 7 for magenta, 0.7 for exposure apparatus 8 for cyan and 1.0 for exposure apparatus 9 for black, so that the light-emitting intensity of the plurality of organic EL elements 30 in exposure apparatus 9 that forms a black electrostatic latent image is different from the light-emitting intensity of the plurality of organic EL elements 30 in exposure apparatuses 6, 7 and 8 that form electrostatic latent images in yellow, magenta and cyan respectively, and so that the light-emitting intensity of the plurality of organic EL elements 30 in exposure apparatus 9 that forms the black electrostatic latent image is higher than the light-emitting intensity of the plurality of organic EL elements 30 in exposure apparatuses 6, 7 and 8 that form the electrostatic latent images in yellow, magenta and cyan respectively.

On substrate 31, a bonding portion of FPC 80 and source driver 81 are connected via an ITO circuit pattern having a metal on a surface (not shown in the figure). The light intensity correction data and the control signals, including the clock signal, the line sync signal and the like, are input to source driver 81, which sets the drive parameters, via FPC 80. FPC 80 that performs interface and source driver 81 that sets the drive parameters constitute driver controller 78.

TFT (Thin Film Transistor) circuit 82 is formed on substrate 31. TFT circuit 82 includes a gate controller and drive circuits (hereinafter referred to as pixel circuits). The gate controller, including a shift register, a data latch unit and the like, controls a timing of turning on and off of organic EL elements 30. The pixel circuits supply the drive currents to individual organic EL elements 30. The pixel circuits are individually provided to respective organic EL elements 30 and are aligned in parallel with the light-emitting element array formed by the organic EL elements 30. As described later, source driver 81 sets in the pixel circuits drive current values for driving individual organic EL elements 30, based on the above-described light intensity correction data. In other words, the drive currents for driving organic EL elements 30 are controlled, so that the light-emitting intensity is different among exposure apparatuses 6, 7, 8 and 9 in the third embodiment.

Externally supplied to TFT circuit 82 of exposure apparatus 9 via FPC 80 are the power sources; the control signals, including the clock signal, the line sync signal and the like; and the image data (1-bit binary data). Based on the power sources and signals, TFT circuit 82 controls the timing of turning on and off of individual organic EL elements 30. Since the image data are 1-bit data in the third embodiment, only turning on and off of respective organic EL elements 30 can be controlled, even when the image data are referred. Thus, as described above, the light intensity correction data are used to set the light-emitting intensity of organic EL elements 30 different among exposure apparatuses 6, 7, 8 and 9.

When image forming apparatus 1 is a system capable of printing multi-value data (i.e., capable of reproducing one pixel in multi-tones) as the image data, it is possible to use the image data so as to set the light-emitting intensity of organic EL elements 30 different in exposure apparatuses 6, 7, 8 and 9. In this case, individual organic EL elements 30 emit light at a plurality of light-emitting intensities associated with the tones. Thus, a key concept of the present invention, that is, “to set the light-emitting intensity different among the exposure apparatuses” can be replaced by a concept, such as “to set the light-emitting intensity different among the exposure apparatuses based on identical image data” or “to set average light-emitting intensity different among the exposure apparatuses.”

Sealing glass 84 is provided to shield organic EL elements 30 from water so as to avoid significant degradation in light-emitting performance, since, due to impact of water, light-emitting zones E (refer to FIG. 4A or 4B) shrink as time lapses or a dark spot may appear inside light-emitting zones E. In the third embodiment, a solid sealing method is employed, in which sealing glass 84 is glued to substrate 31 with an adhesive agent. It is also possible to dispose a drying agent (not shown in the figure) between sealing glass 84 and substrate 31 so as to absorb moisture in sealing area E. Sealing area E generally requires several millimeters to several centimeters in a sub scanning direction from the light-emitting element array formed by organic EL elements. In the third embodiment, a sealing margin of 2,000 μm is secured.

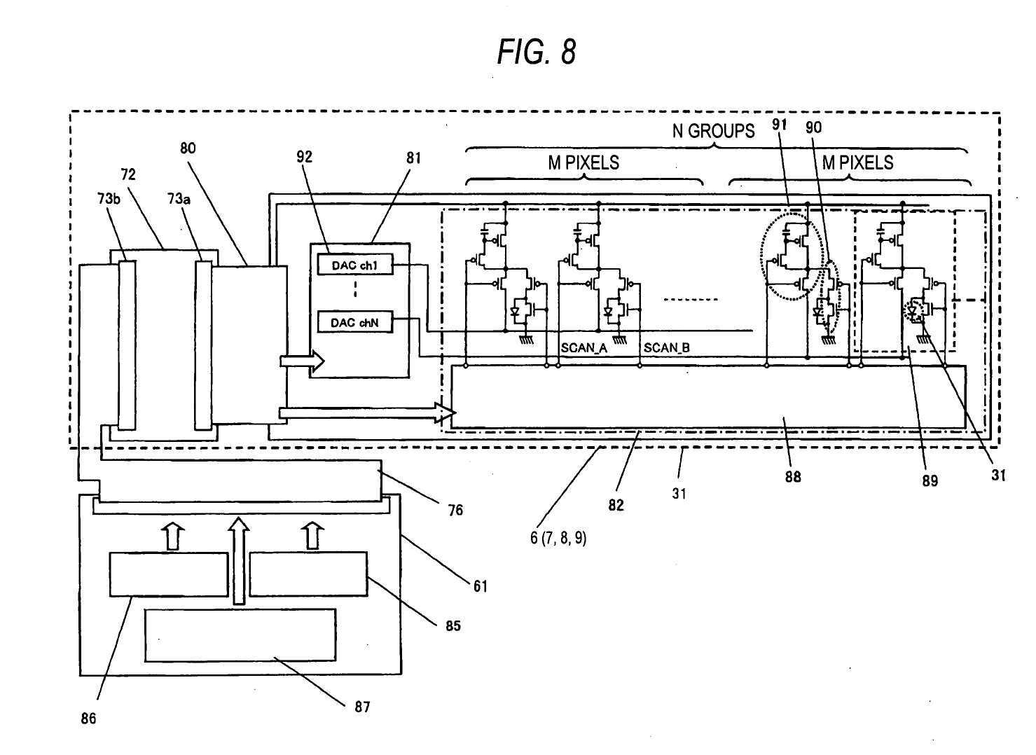

Light intensity sensor unit 77 has a plurality of light intensity sensors, which are formed of amorphous silicon or the like and are disposed along substrate 31 in the main scanning direction. Light intensity sensor unit 77 measures the light-emitting intensity of individual organic EL elements 30. Output from light intensity sensor unit 77 is supplied to TFT circuit 82 via wiring (not shown in the figure). After signal processing, such as amplification and analog-digital conversion, signals are output externally from exposure apparatus 9 via FPC 80, relay substrate 72 (refer to FIG. 6) and cable 76 (refer to FIG. 6). Controller 61 (refer to FIG. 8), which will be described later, receives and processes the signals and generates new light intensity correction data (e.g., 8-bit). In this process, changing a coefficient to multiply the light intensity correction data depending on exposure apparatuses 6, 7, 8 and 9 (refer to FIG. 1), as described earlier, sets the light-emitting intensity of organic EL elements 30 different per exposure apparatuses 6, 7, 8 and 9. It is, though, not required to set the light-emitting intensity of organic EL elements 30 different among all exposure apparatuses 6, 7, 8 and 9. As described earlier, the light-emitting intensity may be set different at ease at least between two of the exposure apparatuses (e.g., the light intensity for exposure apparatuses 6, 7 and 8 is identical, while the light-emitting intensity for exposure apparatus 9 is different from that for exposure apparatuses 6, 7 and 8).

FIG. 8 is a circuit diagram of exposure apparatus 9 of image forming apparatus 1 according to the third embodiment of the present invention. Lighting control by TFT circuit 82 and source driver 81 is described below with reference to FIG. 8.

As shown in FIG. 8, controller 61 is installed in image forming apparatus 1. Controller 61 receives image data from a computer and the like (not shown in the figure); generates printable image data; and, as described above, generates the light intensity correction data, based on the output from light intensity sensor unit 77 (refer to FIG. 7) installed in exposure apparatus 9.

Image memory 85 stores binary image data generated by controller 61, based on a command and the like transferred from the computer and the like (not shown in the figure). Light intensity correction data memory 86 stores the light intensity correction data. Light intensity correction data memory 86 is, for example, a re-writable non-volatile memory such as an EEPROM and the like. A manufacturing process of exposure apparatus 9 includes a process that individually measures the light-emitting intensity and a light-emitting luminance distribution of all organic EL elements 30 of exposure apparatus 9 and that, based on the measurement results, generates light intensity correction data to equalize the light-emitting intensity of respective organic EL elements 30. Light intensity correction data memory 86 stores values of the light intensity correction data.

Controller 61 can update the light intensity correction data to the newly generated light intensity correction data, based on the output from light intensity sensor unit 77 (refer to FIG. 7) described above.

Timing generator 87 generates the control signals relating to timing to drive exposure apparatus 9. The image data stored in image memory 85 and the light intensity correction data stored in light intensity correction data memory 86 (or copied in advance onto a high-speed memory, which is not shown in the figure) are supplied from an end portion of substrate 31 via cable 76, connector B 73b, relay substrate 72, connector A 73a and FPC 80, based on the signals generated by timing generator 87, including the clock signal, line sync signal and the like.

Further, the image data and the timing signals supplied to substrate 31 are supplied to TFT circuit 82 via wiring formed on substrate 31, such as, for example, a metal layer on the ITO. The light intensity correction data and the timing signals are similarly supplied to source driver 81.

TFT circuit 82 is mainly divided into pixel circuits 89 and gate controller 88. One pixel circuit 89 is provided to one organic EL element 30. M pixels of organic EL elements 30 form a group, and N groups are provided onto substrate 31. In the third embodiment, one group contains eight elements (i.e., M=8) and 640 groups exist. Thus, a total number of organic EL elements 30 is 8×640=5,120. In order to set the light-emitting intensity of organic EL elements 30 different among exposure apparatuses 6, 7, 8 and 9, the light-emitting intensity of 5,120 organic EL elements 30 need to be changed at one time.

Each of pixel circuits 89 has driver unit 90 and current program unit 91. Driver unit 90 supplies and controls organic EL elements 30 with currents. Current program unit 91 functions so that an internal capacitor memorizes the current values that source driver 81 supplies to control turning on and off of organic EL elements 30 (i.e., a drive current value for organic EL elements). Thus, pixel circuits 89 can drive organic EL elements 30 at constant current, based on the drive current values pre-programmed at a predetermined timing.

Gate controller 88 includes a shift register that sequentially shifts the input binary image data; a latch unit that, after a predetermined number of pixels are input to a shift register provided in parallel with the shift register, holds the pixels; and a controller that controls a timing for the operations above (none of the components shown in the figure). Gate controller 88 further outputs SCAN_A and SCAN_B signals shown in FIG. 8, so as to control an interval between turning on and off of organic EL element 30 connected to pixel circuit 89 and a timing of a current program period for setting the drive current.

Source driver 81 has internal D/A converters 92 as many as N groups of organic EL elements 30 (640 in the third embodiment). Based on the light intensity correction data supplied via FPC 80 (e.g., 8-bit data), source driver 81 sets the drive currents for individual organic EL elements 30 so as to control and equalize light-emitting luminance of organic EL elements 30.

The configuration allows control of the drive currents to organic EL elements 30 as described above, so as to set the light-emitting intensity different among exposure apparatuses 6, 7, 8 and 9. Using the current program as described above makes it easy to set the light-emitting intensity different among exposure apparatuses 6, 7, 8 and 9, while requiring no additional component to an existing system and thus no cost increase.

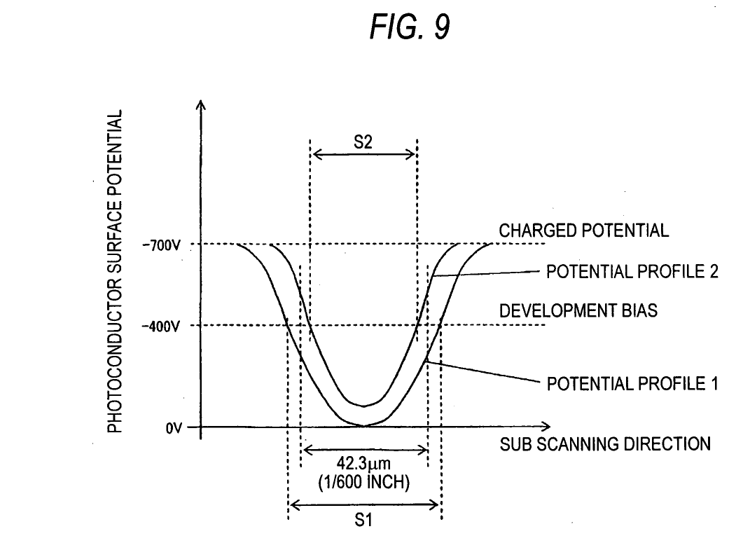

FIG. 9 illustrates a status of an electrostatic latent image formed by the exposure apparatus installed in image forming apparatus 1 according to the third embodiment of the present invention.

Described below with reference to FIG. 9 is change in an pixel area when the light-emitting intensity is different among the exposure apparatuses. For simplicity, it is assumed that the light-emitting intensity is different for exposure apparatus 6 (associated with the yellow image data) and exposure apparatus 9 (associated with the black image data); that the light-emitting intensity of exposure apparatus 9 is higher than that of exposure apparatus 6; and that, under the conditions above, exposure apparatus 6 exposes photoconductor 10 and exposure apparatus 9 exposes photoconductor 13.

In FIG. 9, “charged potential” is an electric potential on photoconductor 10 evenly charged by a charger (not shown in the figure), which is set to, for example, −700V. When exposure apparatus 6 exposes photoconductor 10 charged to such electric potential, a surface potential of a portion exposed to light on photoconductor 10 is shown as potential profile 2. A distribution of the surface potential is equivalent to a generally called electrostatic latent image. The distribution of the electrostatic latent image is as shown in the figure, mostly because photoconductor 10 rotates in the sub scanning direction (direction Y in FIG. 5) as being exposed and light energy exposed on photoconductor 10 becomes higher in a portion exposed for a longer time. In other words, even when the “distribution of the light-emitting intensity” is completely even in light-emitting zones E of respective organic EL elements 30 (refer to FIG. 4), the distribution of the surface potential, as potential profile 2 in FIG. 9 shows, is formed on photoconductor 10 in the sub scanning direction. Developer unit 2 develops an image on photoconductor 10 having such distribution of the surface potential. When a development bias of, for example, −400V is applied to a developer roller (not shown in the figure) provided to developer unit 2, the yellow toner is deposed on area S2 that has an electric potential of a lower absolute value than the development bias (the toner is negatively charged) and yellow pixels are formed on photoconductor 10.

Similarly, when exposure apparatus 9 exposes photoconductor 13 charged to −700V with higher light-emitting intensity than for yellow, a surface potential of a portion exposed to light on photoconductor 13 is shown as potential profile 1. Developer unit 5 develops an image on photoconductor 13 having such distribution of the surface potential. When a development bias of, for example, −400V is applied to a developer roller (not shown in the figure) provided to developer unit 5, the toner is deposed on area S1 having an electric potential of a lower absolute value than the development bias and black pixels are formed on photoconductor 13.

Changing the light-emitting intensity between exposure apparatuses 6 and 9 as described above forms the pixels having different sizes on photoconductors 10 and 13 associated with exposure apparatuses 6 and 9 respectively. The effectiveness to have the different pixel sizes as above is omitted since already described in the first embodiment.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2005-076837 filed on Mar. 17, 2005 and No. 2006-040571 on Feb. 17, 2006, entire content of which is expressly incorporated by reference herein.

What is claimed is:

1. An image forming apparatus, comprising:
a plurality of exposure apparatuses configured to exposure a surface of a photo conductor; and
a plurality of organic electroluminescence elements configured to emit light to the surface of the photo conductor as exposure light, light-emitting intensity of the plurality of organic electroluminescence elements being different among the plurality of exposure apparatuses.

2. The image forming apparatus according to claim 1, wherein the light-emitting intensity of the plurality of organic electroluminescence elements is higher for an exposure apparatus that performs exposure in an earlier stage.

3. The image forming apparatus according to claim 1, comprising four exposure apparatuses that form electrostatic latent images in yellow, magenta, cyan and black respectively, wherein the light-emitting intensity of the plurality of organic electroluminescence elements for the exposure apparatus that forms the black electrostatic latent image is different from the light-emitting intensity of the plurality of organic electroluminescence elements for the exposure apparatuses that form the electrostatic latent images in yellow, magenta and cyan.

4. The image forming apparatus according to claim 3, wherein the light-emitting intensity of the plurality of organic electroluminescence elements for the exposure apparatus that forms the black electrostatic latent image is higher than the light-emitting intensity of the plurality of organic electroluminescence elements for the exposure apparatuses that form the electrostatic latent images in yellow, magenta and cyan.

5. The image forming apparatus according to claim 1, wherein the light-emitting intensity is different among the exposure apparatuses by control of drive currents that drive the plurality of organic electroluminescence elements.

6. An image forming apparatus having a plurality of exposure apparatuses that perform exposure using light emitted from a plurality of organic electroluminescence elements as exposure light, wherein light-emitting zones of the plurality of organic electroluminescence elements are different in at least one of area and shape among the plurality of exposure apparatuses.

7. The image forming apparatus according to claim 6, wherein a total area of the light-emitting zones of the plurality of organic electroluminescence elements is identical among the exposure apparatuses.

8. The image forming apparatus according to claim 6, wherein the area of the light-emitting zones of the plurality of organic electroluminescence elements is larger for an exposure apparatus that performs exposure in an earlier stage.

9. The image forming apparatus according to claim 6, comprising four exposure apparatuses that form electrostatic latent images in yellow, magenta, cyan and black respectively, wherein the shape of the light-emitting zones of the plurality of organic electroluminescence elements for the exposure apparatus that forms the black electrostatic latent image is different from the shape of the light-emitting zones of the plurality of organic electroluminescence elements for the exposure apparatuses that form the electrostatic latent images in yellow, magenta and cyan.

10. The image forming apparatus according to claim 6, comprising the four exposure apparatuses that form electrostatic latent images in yellow, magenta, cyan and black respectively, wherein the area of the light-emitting zones of the plurality of organic electroluminescence elements for the exposure apparatus that forms the black electrostatic latent image is different from the area of the light-emitting zones of the plurality of organic electroluminescence elements for the exposure apparatuses that form the electrostatic latent images in yellow, magenta and cyan.

11. The image forming apparatus according to claim 10, wherein the area of the light-emitting zones of the plurality of organic electroluminescence elements for the exposure apparatus that forms the black electrostatic latent image is larger than the area of the light-emitting zones of the plurality of organic electroluminescence elements for the exposure apparatuses that form the electrostatic latent images in yellow, magenta and cyan.
